(19) United States
(12) Patent Application Publication
(10) Pub. No.: US 2006/0179349 A1
(43) Pub. Date: Aug. 10, 2006

(54) System and method for tracking exceptional states

(75) Inventors: Paul M. Tyma, Broadview Heights, OH (US); Gabriel M. Torok, Shaker Heights, OH (US); William K. Leach, Pepper Pike, OH (US)

Correspondence Address: BENESCH, FRIEDLANDER, COPLAN & ARONOFF LLP;ATTN: IP DEPARTMENT DOCKET CLERK, 2300 BP TOWER, 200 PUBLIC SQUARE, CLEVELAND, OH, 44114, US

(73) Assignee: PREEMPTIVE SOLUTIONS, LLC, CLEVELAND, OH (US)

(21) Appl. No.: 11/053,969

(22) Filed: Feb. 9, 2005

(51) Int. Cl. G06F 11/00

(52) U.S. Cl. 714/38

(57) ABSTRACT

Methods and systems for automated notification of exceptional states are described. A system may identify candidate exceptional state locations to inject program code and report reaching the exceptional state to a location. Such reporting may be to a local repository or remote receiver. A method may automate identifying exceptional state conditions and reporting attributes associated with the conditions.

### TECHNICAL FIELD

The disclosure relates to the software arts and finds particular application in metadata rich programming environments, such as Java and .NET and other stack based virtual machine environments. More particularly, this disclosure relates to a method and system for injecting code which introduces and extends existing exceptional state reporting facilities, if any.

### BACKGROUND

Some programming environments, such as the Java and NET programming environments provide and sometimes require facilities to handle exceptional program states. Such states can be as innocuous, for example a calculation that is not correct or an application reaching a point without receiving required input thus, preventing continuation. Because of this facility, Java and .NET applications are highly controllable, even in the case of errors.

Unfortunately however, the notification of those conditions is typically limited to the immediate user of the application. Typically, the user can then via email or phone report the exceptional state. Given that thousands of such exceptional states can occur in one simple execution of an application, it's unlikely that such manual reporting will take place. Because of this, end users tend to only give notification to the programmers in extreme cases.

Alternatively, a programmer could insert notification code manually. However, this is an impractical solution for a typical programmer that creates many programs and program parts over time.

### SUMMARY

The disclosure provides a method and system for injection of software to notify interested parties, such as programmers, of exceptional program states. Programmers typically predefine such states, however the disclosure provides a method and system to determine, and create if needed, locations to monitor for exceptional states. Programmers may also enjoy an additional level of configurability.

The disclosure provides a method and system to allow programmers to be notified of all or any subset of exceptional states that occur through an application in an automated way. Such notice may help identify areas where future improvements to the application are needed or desirable.

In one embodiment, once those locations are determined, code may be injected into the existing application to transmit messages about the exceptional state or exceptional state attributes to a repository or remote location. This may be used by developers to fix program bugs, modify program behavior, or track feature usage.

### BRIEF DESCRIPTION OF THE DRAWINGS

FIG. 1 is a component block diagram of an exemplary system for handling exceptional states.

FIG. 2 is a logic diagram illustrating an exemplary apparatus for handling exceptional states including exceptional state logic.

FIG. 3 is a flowchart and logical diagram illustrating exemplary handling of exceptional states including recording, archiving and transmitting exceptional state conditions.

FIG. 4 is a flowchart and logical diagram illustrating exemplary handling of exceptional states including recording, reporting and resetting exceptional state conditions.

FIGS. 5A and 5B are flowcharts illustrating an exemplary method for inserting and resetting exceptional states to a permissible condition.

### DETAILED DESCRIPTION

The following includes definitions of selected terms employed herein. The definitions include various examples and/or forms of components that fall within the scope of a term and that may be used for implementation. The examples are not intended to be limiting. Both singular and plural forms of terms may be within the definitions.

“Address”, as used herein, includes but is not limited to one or more communication network accessible addresses, device identifiers, IP addresses, e-mail addresses, a distribution list including one or more e-mail addresses, url and ftp locations or the like, network drive locations, or other types of addresses that can identify a desired destination or device.

As used in this application, the term “computer component” refers to a computer-related entity, either hardware, firmware, software, a combination thereof, or software in execution. For example, a computer component can be, but is not limited to being, a process running on a processor, a processor, an object, an executable, a thread of execution, a program, and a computer including component parts thereof. By way of illustration, both an application running on a server and the server can be computer components. One or more computer components can reside within a process and/or thread of execution and a computer component can be localized on one computer and/or distributed between two or more computers.

“Computer communication”, as used herein, refers to a communication between two or more computer components or computing devices (e.g., computer, personal digital assistant, cellular telephone) and can be, for example, a network transfer, a file transfer, an applet transfer, an email, a hypertext transfer protocol (HTTP) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, and so on.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, optical or magnetic disks, dynamic memory and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic medium, a CD-ROM, other optical medium, punch cards, paper tape, other physical medium with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate signals, instructions, data, or other software over a network, like the Internet, can be considered a “computer-readable medium.”

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Exceptional state”, as used herein, includes both failure and non-failure states of a software application. Exceptional states do not necessarily correspond to program failures and do not necessarily result in application termination. Software may be included to detect exceptional states that may eventually lead to failure and report them. Additionally, software may be included to detect “benign” or non-failure exceptional states of interest to users or programming staff for reporting.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), a programmed logic device like a field programmable gate array (FPGA), a memory device containing instructions, combinations of logic devices, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical and/or physical communication channels can be used to create an operable connection.

“Signal”, as used herein, includes but is not limited to one or more electrical or optical signals, analog or digital signals, data, one or more computer or processor instructions, messages, a bit or bit stream, or other means that can be received, transmitted and/or detected.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may be dependent on, for example, requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein include programming languages and tools like Java, .NET, Pascal, C#, C++, C, CGI, Perl, SQL, APIs, SDKs, assembly, firmware, microcode, and/or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User”, as used herein, includes but is not limited to one or more persons, software, computers or other devices, or combinations of these.

“Internet”, as used herein, includes a wide area data communications network, typically accessible by any user having appropriate software.

“Intranet”, as used herein, includes a data communications network similar to an internet but typically having access restricted to a specific group of individuals, organizations, or computers.

“Network”, as used herein, includes but is not limited to the internet, intranets, Wide Area Networks (WANs), Local Area Networks (LANs), and transducer links such as those using Modulator-Demodulators (modems).

Network Communication Protocol Examples: Communication between a client computer and a server may take place using one of several network protocols, such as hypertext transfer protocol (HTTP), file transfer protocol (FTP), Common Internet File System (CIFS) protocol, Gopher, other available protocol, or a custom protocol. For purposes of simplicity, the following example will be primarily described with respect to HTTP.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

In one embodiment, a method and system is described for injecting code configured to detect and report exceptional states. It is generally up to the programmer and secondarily the designers of stack based virtual machine environments such as Java and NET, to define which program states are exceptional. In many if not most cases, these states are situational. For example, wherever a programmer has or could have defined a “try block.” This block indicates the possibility of an exceptional state and permits detection and automatic insertion of exceptional code by an injection tool. Alternately, a programmer may review a section of code and identify a desired exceptional state location in a program module through the use of a GUI tool or a configuration file.

The condition could be completely harmless in the context of program execution. That is, an exceptional state as defined by the programmer may not correlate to anything unusual to the end-user of the application. As a concrete example, a certain program operation may require the application to exceed some programmer-expected memory requirement. In certain situations this condition does not hamper the continuation of the application, and in fact, may be transparent to the end-user, but may be of architectural interest to the developer.

Java and NET application design could detect this state, however there may be no specific facility to notify the programmer, quality assurance (QA) department and/or other remote, interested parties. For a variety of reasons, asking end-users to relay such seemingly irrelevant information is not feasible especially since the end-user may not recognize the importance of the condition, and is likely to be more interested, thus compliant, in reporting total application failures rather than those exceptional states interesting to the programmer.

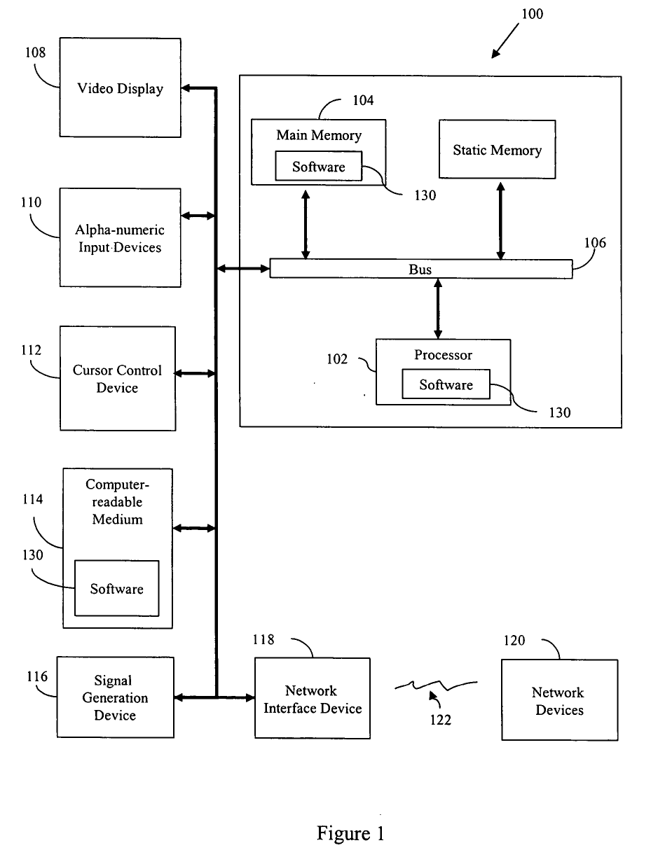

FIG. 1 illustrates an example computing device 100 in which example systems and methods described herein, and equivalents, can operate. The computing device 100 includes a processor 102 in computer communication with a computer-readable medium shown as main memory 104, via a bus 106. The computing device 100 is further shown to include a video display unit 108, for example, a liquid crystal display (LCD), a cathode ray tube (CRT), and the like. The computing device 100 also includes an input device 110, for example, a keyboard; a cursor control device 112, for example, a mouse or trackball and the like; a computer-readable medium 114, for example a disk drive unit, memory stick and the like; a signal generation device 116, for example, a speaker; and a network interface device 118 which may permit the computing device 100 to be in computer communication with other computer components such as network devices 120 over a network 122. The computer-readable medium 114 may include software 130 to be completely or partially loaded into the main memory 104 and/or within the processor 102. In one embodiment, the software 130 may be transmitted or received via the network interface device 118.

The computer-readable medium 114 may be configured as disk operably connected to the processor 102. The disk can include, but is not limited to, devices like a magnetic disk drive, a solid state disk drive, a floppy disk drive, a tape drive, a Zip drive, a flash memory card, and/or a memory stick. Furthermore, the disk can include optical drives like a CD-ROM, a CD recordable drive (CD-R drive), a CD rewriteable drive (CD-RW drive), and/or a digital video ROM drive (DVD ROM). The main memory 104 can store processes and/or data, for example. The disk and/or memory 104 can store an operating system that controls and allocates resources of the computing device 100.

The bus 106 can be a single internal bus interconnect architecture and/or other bus or mesh architectures. While a single bus is illustrated, it is to be appreciated that computing device 100 may communicate with various devices, logics, and peripherals using other busses that are not illustrated (e.g., PCIE, SATA, Infiniband, 1394, USB, Ethernet). The bus 106 can be of a variety of types including, but not limited to, a memory bus or memory controller, a peripheral bus or external bus, a crossbar switch, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The computing device 100 can operate in a network environment and thus may be connected to network devices 120 via the I/O devices 118. Through the network devices 120, the computing device 100 may interact with a network and establish computer communication with a remote repository as more fully explained below. Through the network, the computing device 100 may be logically connected to remote computer components. Exemplary networks 122 with which the computing device 100 may interact include, but are not limited to: a local area network (LAN), a wide area network (WAN), and other networks. The network devices 120 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), and the like. Similarly, the network devices 120 can connect to WAN technologies including, but not limited to, the internet, intranets, point to point links, circuit switching networks like integrated services digital networks (ISDN), packet switching networks, and digital subscriber lines (DSL).

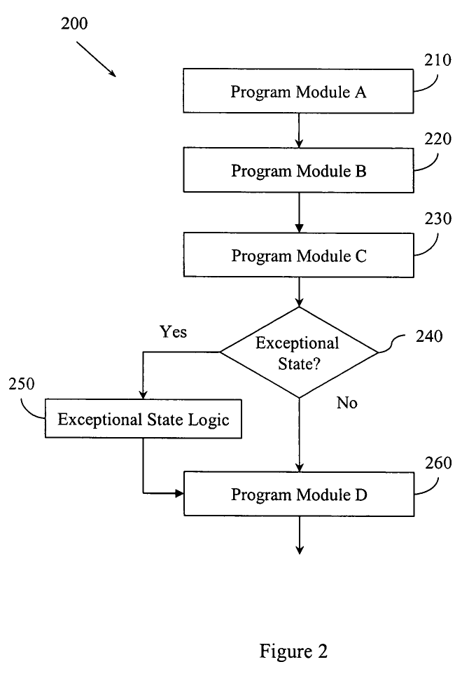

Example methods may be better appreciated with reference to the flow diagrams of FIGS. 2 through 5. While for purposes of simplicity of explanation, the illustrated methodologies are shown and described as a series of blocks, it is to be appreciated that the methodologies are not limited by the order of the blocks, as some blocks can occur in different orders and/or occur concurrently with other blocks from that shown and described. Moreover, less than all the illustrated blocks may be required to implement an example methodology. Furthermore, additional and/or alternative methodologies can employ additional, not illustrated blocks.

In the flow diagrams, blocks denote “processing blocks” that may be implemented with logic. In the case where the logic may be software, a flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on are not shown. It will be further appreciated that electronic and software logic may involve dynamic and flexible processes so that the illustrated blocks can be performed in other sequences that are different from those shown and/or that blocks may be combined or separated into multiple components. It will be appreciated that the processes may be implemented using various programming approaches like machine language, procedural, object oriented and/or artificial intelligence techniques. The foregoing applies to all methodologies herein.

FIG. 2 shows an embodiment of an exemplary software process 200 adapted for notification of exceptional states. Many software programs execute through a series of program modules 210, 220, 230, 260. Software travels into and out of various program modules many of which have a possibility of creating exceptional states. Some of these modules will be of specific interest to programmers to understand their application. The program modules or sections thereof that may create exceptional states may be system or programmer defined. As illustrated, program module C 230 has been identified as potentially creating an exceptional state. Software 240 configured to identify the exceptional state has been inserted or injected to detect the exceptional state upon occurrence. When detected, exceptional state logic 250 acts on the exceptional state as further described below and returns the process 200 to the next program module 260. In the event no exceptional state is detected in program module 230, the process proceeds normally to program module 260.

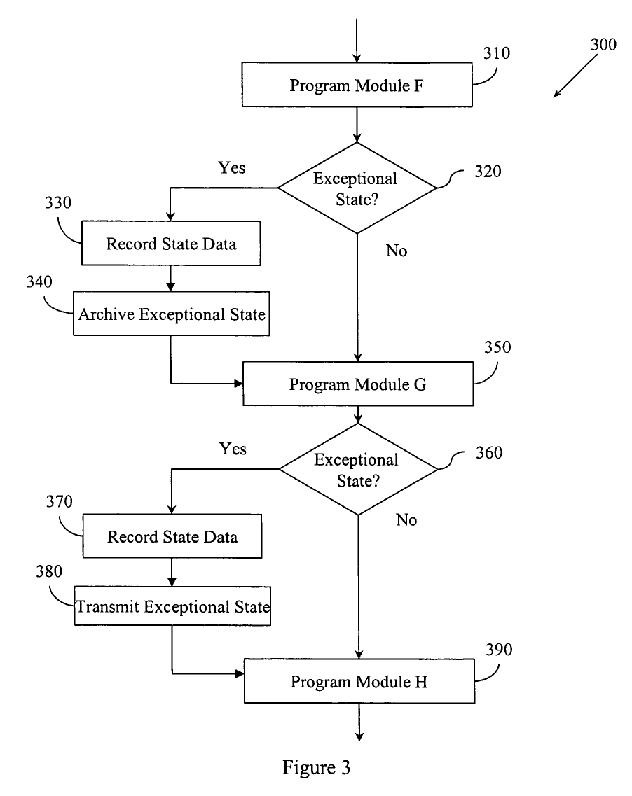

FIG. 3 shows an embodiment of an exemplary software process 300 adapted for notification of exceptional states. As the software process executes into program module F 310, software 320 evaluates execution of the module 310. Upon occurrence of an identified condition, state data is recorded 330 and the exceptional state is archived internally 340. It can be appreciated that the archiving feature can be implemented internal to the computing device, for example exceptional state data may be stored in a computer-readable medium.

Continuing with reference to FIG. 3, the software process 300 continues to program module G, 350 also being observed for occurrences of, for example, a different exceptional state. In this instance, the exceptional state data is recorded 370 and transmitted 380 to a repository. It can be appreciated that the recorded exceptional state data may be sent over a network to a remote location, such as over an intranet to the IT department, or over the internet to the software manufacturer.

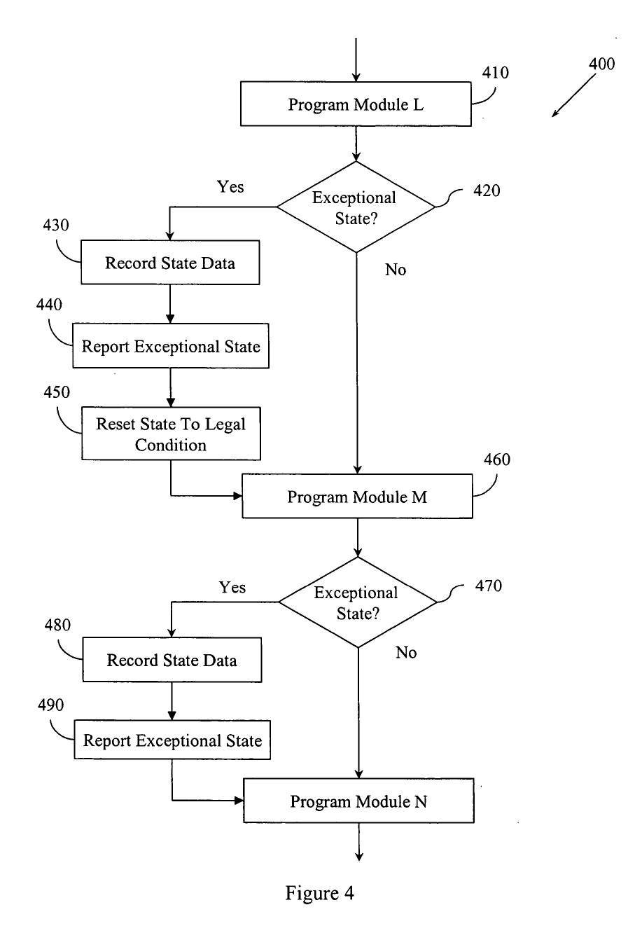

FIG. 4 shows an embodiment of an exemplary software process 400 adapted for notification of exceptional states. As the software process executes into program module L, 410, software 420 evaluates execution of the module 410. Upon occurrence of an identified condition, state data is recorded 430, the exceptional state is reported 440 (either internally or externally), and the exceptional state may be reset to an appropriate condition 450. For example, if the exceptional state was a zero divisor, the exceptional state logic may change the divisor to a small non-zero value and/or alert the user to the condition. Resuming the process 400, program module M, 460, is also monitored for an exceptional state. For example, exceptional states may be specified by the original programmer or someone with an interest in certain conditions. For example, exceptional state software 470 may be configured to monitor for a certain button to be selected in a graphical user interface (GUI). Upon occurrence, the condition is recorded, 480, and reported 490. It should be clear that selecting the GUI button is not in any way construed as an erroneous state, in this instance it is merely something the programmer is interested in knowing about. For example, it is possible that a given button is tied to a feature the programmer wishes to track. For the duration of tracking, the button push can be considered an exceptional state.

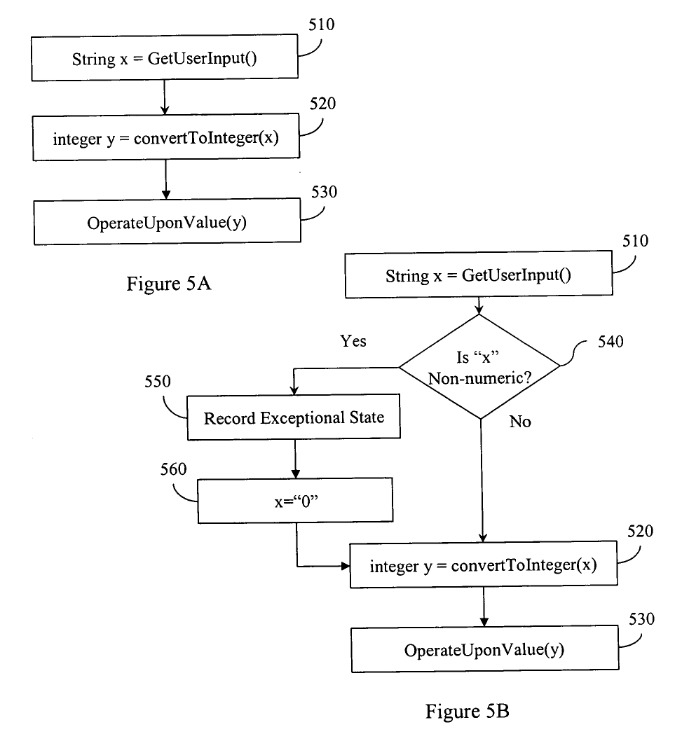

Illustrated in FIGS. 5A and B is an embodiment of a methodology 400 for exceptional state handling. The illustrated elements denote “processing blocks” and represent software instructions or groups of instructions that cause a computer or processor to perform an action(s) and/or to make decisions. Alternatively, the processing blocks may represent functions and/or actions performed by functionally equivalent circuits such as a digital signal processor circuit, an application specific integrated circuit (ASIC), or other logic device. The diagram, as well as the other illustrated diagrams, do not depict syntax of any particular programming language. Rather, the diagram illustrates functional information one skilled in the art could use to fabricate circuits, generate software, or use a combination of hardware and software to perform the illustrated processing. It will be appreciated that electronic and software applications may involve dynamic and flexible processes such that the illustrated blocks can be performed in other sequences different than the one shown and/or blocks may be combined or, separated into multiple components. They may also be implemented using various programming approaches such as machine language, procedural, object oriented and/or artificial intelligence techniques. The foregoing applies to all methodologies described herein.

With reference to FIG. 5A, an example portion of a software process includes obtaining a user's input and storing that input as a string X, Block 510, converting the string X into an integer and storing that result as integer Y, Block 520, and performing a defined operation on integer Y, Block 530. A programmer may deem that a non-numeric entry X is normal or such entry may be considered to be an exceptional state when the process attempts to convert the non-numeric entry to an integer in Block 520. Exceptional state software can be inserted to handle the exceptional state as illustrated in FIG. 5B.

FIG. 5B illustrates an example portion of the software process of FIG. 5A with exceptional state software inserted. As shown, the process may include obtaining a user's input and storing that input as a string X, Block 510. Exceptional state software may analyze the entry to determine if the exceptional state condition is met, Block 540. If so, the exceptional state, or other data corresponding to system resources at the time of the exceptional state may be recorded, Block 550. Further, software may, in appropriate circumstances, reset the condition to a legal or non-exceptional state, Block 560. From there the original software process may be resumed Block 520.

Upon encountering the exceptional state, the injected software code may notify a remote repository, such as network devices 120 (FIG. 1) via for example, a network, and may take further action.

The data collection embodiment, such as a server at a remote repository, may function in several ways. In one, the server may be configured to act as a repository of exceptional state messages from machines running the application of interest. It may collect that data simply as raw data to be stored in a simple dump file or alternately, a back-end database. The repository may also contain logic to group similar messages or those having common attributes. For example, if an exceptional state occurs often, it is possible that thousands of messages may come to the repository. If the mere occurrence of the state is of interest, rather than the system attributes reported upon reaching the exceptional state, those thousands of messages may be reduced to a single message for reporting the occurrence data. This information may be forwarded upon occurrence or in bulk at intervals.

In one embodiment, the repository can be configured to interface with existing bug tracking products and may provide facilities for bug tracking vendors to write additional interfaces if they choose. That is, the repository may insert issues directly into the bug-tracking software for programmer viewing. The detection and repository features may be static or configurable to meet individual desires.

In another embodiment, relevant information is collected regarding the program state or data of the program module. This can include any information the programmer or interested party wishes to know about the state including variable values, time-of-day, system information, usage statistics, log files, screenshots, program location, method call paths, and the like.

In one embodiment, sections of code are detected and noted as possible exceptional state areas. Note that programmers may insert logic to directly create such an area.

In another embodiment, a person such as programmer of the original application can specify which areas of exceptional state are of interest to him or her. In addition, he or she may specify what types of notifications should be sent, that is, types of information including data or things like program state values, screenshots, user system configuration, and the like.

In another embodiment, the receiver of the information, for example, a local or remote repository, may collect, merge, and categorize the information as needed or pursuant to established rules.

It may be the likely outcome that the original programmer would utilize the collected data to improve or simply monitor the application. Such information could yield information as to a preferable design for future versions of the application or give clues as to how an application is being used by its users. The latter could sway future development efforts to focus on application features now known to be in high demand from users.

Although the method and system has been described above as implemented in a preferred application program module, it will be understood that alternative embodiments will become apparent to those skilled in the art without departing from its spirit and scope.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Thus, this application is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Gamer, A Dictionary of Modem Legal Usage 624 (2d. Ed. 1995).

What is claimed is:

1. A method for tracking run-time exceptional states in a program module, the method comprising:
identifying a point in the program module where exceptional state tracking is desirable;
injecting exceptional state logic associated with the identified point in the program module, the exceptional state logic configured to recognize a run-time exceptional state; and
upon recognition of a run-time, non-failure exceptional program state, receiving data regarding the run-time, non-failure exceptional state at a remote receiver.

2. The method of claim 1, further comprising following the receiving step:
comparing the data to previously reported data regarding exceptional states.

3. The method of claim 1, further comprising prior to the identifying step:
detecting existing exceptional state handling code in the program module.

4. The method of claim 1, wherein the identifying comprises locating a point in the program module defined by a user of the program module.

5. The method of claim 1, wherein the identifying comprises locating a point in the program module identified by attributes of the program module.

6. The method of claim 1, where the receiving data comprises receiving data over a network configured to provide computer communication between the exceptional state logic and a computer component located at the remote receiver.

7. The method of claim 1, where the receiving data comprises receiving data collected over a period of time.

8. The method of claim 1, where the exceptional state logic is further configured to collect data upon recognition of the run-time exceptional state.

9. The method of claim 1, where the receiving data comprises receiving data describing run-time, non-failure exceptional state including at least one of: variable values, system information, program location, log files, screenshots, and method call tree.

10. The method of claim 1 further comprising the steps of:
presenting received data to a user; and
responsive to user action, categorizing received run-time exceptional states associated with the received data.

11. A system for reporting an exceptional state in a stack based virtual machine environment program module executing on a computer comprising:
exceptional state logic associated with the program module, the exceptional state logic being configured to recognize a run-time exceptional state and select data corresponding to the run-time exceptional state; and
data gathering logic associated with the program module, the data gathering logic configured to gather selected data upon recognition of the run-time exceptional state.

12. The system of claim 11, further comprising data transmitting logic associated with the computer, the data transmitting logic configured to transmit selected data over a network to a remote receiver.

13. The system of claim 11, further comprising exceptional state identifying logic configured to identify a point in the program module where exceptional state tracking is desirable.

14. The system of claim 11, further comprising injection logic configured to inject the exceptional state logic at an identified point in the program module.

15. The system of claim 11, further comprising reset logic configured to reset the run-time exceptional program state to a permissible condition.

16. An article of manufacture embodied in a computer-readable medium for use in a computer component, the article of manufacture comprising:
first software instructions to detect a run-time exceptional state in a program module, where the exceptional state does not cause program termination;
second software instructions to record data temporally associated with the exceptional state; and
third software instructions to report the data associated with the exceptional state.

17. The article of manufacture as set forth in claim 16, further comprising fourth software instructions to reset the exceptional state to a permissible condition and resume execution of the program module where the exceptional state does not cause program termination.

18. The article of manufacture as set forth in claim 16, further comprising:
fifth software instructions to parse the program module and identify existing exceptional state locations in the program module prior to running the program module.

19. The article of manufacture as set forth in claim 16, where the third software instructions report the data associated with the exceptional state over a network.

20. The article of manufacture as set forth in claim 16, where the third software instructions report the data associated with the exceptional state over a network without user interaction.

21. A method for reporting an exceptional state in a NET or Java program module executing on a computer comprising:
identifying an exceptional state during execution of the program module; and
reporting information upon identification of the exceptional state to a remote device over a network.
